(19) United States
(12) Patent Application Publication
(10) Pub. No.: US 2026/0316372 A1
(43) Pub. Date: Oct. 15, 2026

(54) FORMING TOOL, FORMING MACHINE AND METHOD FOR PRODUCING CONTAINERS WITH UNDERCUTS

(71) Applicant: Marbach Werkzeugbau GmbH, Heilbronn (DE)

(72) Inventors: Klaus WEIBLER, Bretzfeld-Bitzfeld (DE); Daniel PORADA, Bad Rappenau (DE)

(21) Appl. No.: 19/106,549

(22) PCT Filed: Oct. 10, 2022
(86) PCT No.: PCT/EP2022/078030

§ 371 Date: Feb. 25, 2025

(51) Int. Cl. B29C 51/30; B29C 51/34; B29C 51/44; B29L 31/00

(52) U.S. Cl. CPC B29C 51/306; B29C 51/343; B29C 51/44; B29L 2031/712

(57) ABSTRACT

The disclosure relates to a forming tool, in particular a thermoforming tool, for producing a container. The forming tool includes a mold insert having a first mold insert part and a second mold insert part that together define a cavity provided for reshaping a two-dimensional web of material into a container The first mold insert part includes at least one protrusion and is mounted horizontally movable in the forming tool; and an actuation mechanism designed to move the first mold insert part horizontally inward into a molding position, in which the at least one protrusion extends into the cavity to generate an undercut region in the cavity. Further, a method of producing a container from a two-dimensional web of material by using the above-mentioned forming tool is provided.

### TECHNICAL FIELD

The invention relates to a forming tool, in particular a thermoforming tool, to a forming machine, to a use of such a forming tool, and to a method for producing containers from a two-dimensional web of material.

### PRIOR ART

Molding and shaping tools are known from the prior art that are embodied for reshaping two-dimensional (planar) sheets or webs of material into three-dimensional containers, such as, for example, cups, bowls, or capsules. Such articles are employed in the foodstuffs indus-try for packing foodstuffs, for instance. The containers may be produced from plastic material or a different material, such as, for example, sheet or cellulose.

Thermoforming is frequently used for producing plastic containers. Thermoforming methods and thermoforming tools for producing plastic containers are described, for example, in EP 1 541 320A1, EP 1 163 996 B1 and DE 10 2016 103 237A1. Such thermoforming tools comprise an upper tool part and a lower tool part that are arranged coaxially with one another and are movable along the common axis. The upper tool part has at least one downholder device and a pre-stretcher mounted displaceable therein. The lower tool part has a molding device having at least one mold insert and one mold bottom. EP 1 163 996 B1 teaches a two-part axially displaceable mold bottom for molding a container with a hollow base. Regardless of the specific configuration of the mold bottom, mold insert and mold bottom are embodied and arranged such that together they form a cavity (hollow space) with mold side wall and mold bottom which reproduce the shape of the container to be molded.

During a thermoforming process, first a thermoplastic film is heated and arranged between the upper mold part and the lower mold part. The two mold parts are then closed (i.e., moved to one another). The heated plastic film is pressed into the cavity, and thus pre-formed, using the pre-stretcher. For complete molding, compressed air (also called molding air) is discharged into the cavity and/or a negative pressure (vacuum) is produced in the cavity. This presses the pre-molded film further against the mold side wall (formed by the inner wall of the mold insert) and the mold bottom. The plastic film thus completely molded is then cooled, so that a container with rigid walls is created. The container is then released (demolded) from the mold side wall and mold bottom. This demolding may be mechanical, for example using a slight lifting of the mold bottom into the cavity (that is, lifting of the mold bottom counter to the direction of the mold). The lift movement generally causes the container to release completely from the mold side wall. Then further lifting of the mold bottom can remove (eject) the container from the cavity.

Compared to other manufacturing techniques, such as, for example, injection molding methods, thermoforming tools and thermoforming methods have the advantage that as a rule the tools can be equipped with a number of mold inserts arranged adjacent to one another. Thus, a plurality of containers can be produced in one molding cycle. In addition, the molding cycle times are short, so that a higher throughput of containers can be attained. However, it is a drawback that thermoforming tools and thermoforming methods are only suitable for producing containers with undercuts under certain conditions. For example, it is difficult to reliably produce containers with undercuts running continuously in the circumferential direction of the container. Such undercuts may be desirable, for one example, in the vicinity of the container opening or container bottom for the purpose of stacking containers, and, for another example, for enhancing cup stability. If the undercuts are too large or are too prominent, it is difficult to demold the containers without destroying them in the process.

It is therefore an object of the present invention to provide a technique that overcomes the disadvantages described in the foregoing. In particular, it is the object of the present invention to provide a molding tool and molding method that make it possible to produce containers with (pronounced) undercuts.

### SUMMARY

To attain the aforesaid object, according to a first aspect a forming tool, in particular a thermoforming tool, is provided for producing a container. The forming tool comprises a mold insert comprising a first mold insert part and a second mold insert part that together define (or delimit) a cavity provided for reshaping a two-dimensional web of material into a container, wherein the first mold insert part comprises at least one protrusion and is mounted horizontally movable in the forming tool; and an actuation mechanism designed to move the first mold insert part horizontally inward into a molding position, in which the at least one protrusion extends into the cavity to generate an undercut region in the cavity.

The term “two-dimensional web of material” may refer to a film made of plastic (referred to briefly as plastic film in the following) or some other material film or material layer that is designed to be converted to a three-dimensional shape using the effects of external forces (e.g., mechanical force by using a pre-stretcher, and/or pneumatic force by applying compressed air and/or a vacuum). In particular, a thermoplastic film can be used during production of the container.

The cavity is embodied in the interior of the mold insert that is built up by the first insert part and second insert part. More specifically, the cavity is a hollow space in the mold insert that is delimited in horizontal direction by at least one inner side wall of the mold insert (mold insert parts) and in vertical direction by a bottom (bottom wall). The shape of the bottom or bottom wall together with the shape of the at least one inner side wall of the mold insert define the shape of the cavity and thus also the shape of the container to be produced. The shape of the cavity may be cubic, frustoconical, conical or cylindrical depending on the shape of the container to be formed.

Hereinafter the singular term “cavity” is used. Instead of one cavity a plurality of cavities may be embodied by the mold insert that is built up by the first mold insert part and second mold insert part so that a plurality of containers can be molded simultaneously during a single molding cycle. The present invention does not depend on the number of cavities formed by the mold insert and the singular term “cavity” used hereinafter has to be construed to also encompass the plural term “cavities” or “a plurality of cavities”.

According to one implementation, the bottom may be formed integrally with the mold insert, in particular with the second mold insert part. According to an alternative implementation the bottom may be designed as a separate piece that is (movably) received in the mold insert, in particular in the second mold insert part. In such an implementation, the bottom may be movable in vertical direction with respect to the mold insert (second mold insert part).

The first mold insert part may be designed to define a first portion of the cavity where the at least one protrusion is located. For example, the first portion of the cavity may be an upper portion of the cavity comprising an open edge region of the cavity (i.e., the opening of the cavity). The open edge region of the cavity may comprise the upper portion of the at least one inner side wall of the cavity and, optionally, a rim portion. Thus, the first mold insert part may be designed to define the upper portion of the cavity that includes the at least one protrusion.

The second mold insert part may be designed to define a second portion of the cavity. The second portion of the cavity may be a lower portion of the cavity comprising the bottom of the mold cavity and/or a lower portion of the at least one side wall of the cavity. That is, the second mold insert part may be designed to define the bottom of the cavity and/or the lower portion of the at least one side wall of the cavity. Hence, the first mold insert part and the second mold insert part define (build) together the desired cavity provided to form a desired container.

Alternatively, and depending on the container to be molded it is also conceivable that the at least one protrusion is positioned in the middle portion of the cavity or the lower portion of the cavity. To realize such a container design, the first mold insert part may be designed to define the middle side wall portion or lower side wall portion of the cavity that comprises the at least one protrusion. Moreover, the second mold insert part may be designed to define the remaining portion(s) of the at least one side wall of the cavity that do not comprise the at least one protrusion. If the at least one protrusion is to be arranged in the middle portion of the cavity, the at least one sidewall defined by the second mold insert part may comprise at least one recess or opening in horizontal direction. The at least one protrusion of the first mold insert part can then be moved through the at least one opening or recess of the second mold insert part into the cavity to realize the molding position. Moreover, the at least one protrusion of the first mold insert part can be removed from the cavity through the at least one opening or recess of the second mold insert part to realize the demolding position.

The actuation mechanism may be further designed to move the first mold insert part horizontally outward from the molding position into a demolding position, in which the at least one protrusion is retracted from the cavity. Hence, the actuation mechanism is designed to horizontally move the first mold insert part in a reciprocating manner between the molding position and the demolding position.

The first mold insert part may consist of at least two sections arranged in circumferential direction. Depending on the specific shape of the at least one protrusion and/or its extension in circumferential direction, the first mold insert part may be built up of two, three, four or more sections arranged in circumferential direction to build up the first mold insert part. According to one implementation the first mold insert part may consist of (only) two sections in circumferential direction (i.e., two half sections). According to another implementation, the first mold insert part may consist of four sections in circumferential direction (i.e., four quarter sections). Independent of the specific number of sections that build up the first mold insert part, the actuation mechanism is designed to move each section of the first mold insert part in a reciprocating manner in horizontal direction (i.e., horizontally inward and horizontally outward). In other words, the actuation mechanism is operatively coupled with each section of the first mold insert part to move each section individually between the molding and demolding positions. This design enables a careful demolding of a container from the mold insert cavity.

Depending on the specific needs the second mold insert part may be designed as a single piece, for instance as a sleeve or block element with a hollow space, with at least one inner side wall to define the lower portion of the cavity. In addition, the second mold insert part may be mounted stationary in the forming tool. “Mounted stationary” means that the second mold insert part is mounted immovable in the forming tool. With such a design of the second mold insert part the complexity of the whole forming tool is further reduced.

The actuation mechanism may be implemented as a pivoting mechanism. In such a case, the first mold insert part may be pivotally mounted in the forming tool. The first mold insert part may be pivotally mounted in the forming tool such that the first mold insert part horizontally pivots with respect to the second mold insert part between the molding and demolding positions. More specifically, each of the at least two sections of the first mold insert part is pivotally mounted in the forming tool such that each of the at least two sections can horizontally pivot between the molding and demolding positions (i.e., pivot horizontally inward and horizontally outward with respect to the second mold insert part). The described pivoting in horizontal direction of the first mold insert part with respect to the second mold insert part enables a compact design of the whole forming tool.

The first mold insert part is arranged in the forming tool to at least partially surround the second mold insert part in circumferential direction of the forming tool. In addition, the first mold insert part may be movably mounted (pivotally mounted) on the second mold insert part. More specifically, each section of the first mold insert part may be movably mounted (pivotally mounted) on an outer side(s) of the second mold insert part. By directly mounting (each section of) the first mold insert part on the second mold insert part a compact mold insert design is obtained.

Depending on the undercut to be generated the at least one protrusion of the first mold insert part may extend in circumferential direction with or without interruptions. Moreover, the horizontal extension of the at least one protrusion is adapted to the undercut shape to be molded. Still further the at least one protrusion may be located on a lower portion, middle portion or upper portion of the first mold insert part or on the top end of the first mold insert part.

The actuation mechanism may comprise at least one actuation element mounted vertically movable in the forming tool. The at least one actuation element may be operatively connected with the first mold insert part (with each section of the first mold insert part) to move (pivot) the first mold insert part (to move each section of the first mold insert part) horizontally inward into the molding position when the at least one actuation element is moved along a first vertical direction. Moreover, the at least one actuation mechanism may be operatively connected with the first mold insert part (with each section of the first mold insert part) to move (pivot) the first mold insert part (to move each section of the first mold insert part) horizontally outward into a demolding position when the at least one actuation element is moved along a second vertical direction. The vertical movement of the at least one actuation element may be a reciprocating translation in the first and second vertical di-rections. The first vertical direction may be a vertical translation in upward direction. The second direction may be a vertical translation in downward direction. Due to the cooperation of the first mold insert part (each section of the first mold insert part) with the at least one actuation element it is possible to transmit a translation motion of the at least one actuation element in vertical direction into a corresponding pivoting motion of the first mold insert part (or its sections) in horizontal direction.

Optionally, the actuation mechanism may further comprise a biasing mechanism designed to push the first mold insert part horizontally outward into the demolding position when the at least one actuation element is moved along the second direction (i.e., vertically in downward direction). The biasing mechanism may comprise at least one spring that cooperates with the first mold insert part (each section of the first mold insert part) such that the first mold insert part (or each section of the first mold insert part) is pushed horizontally outward by the at least one spring when the at least one actuation element is moved along the second direction. Moreover, the at least one spring cooperates with the first mold insert part (or each section of the mold insert part) such that the at least one spring is compressed (and therefore pre-biased) by the first mold insert part (by the sections of the first mold insert part) when the at least one actuation element is moved in the first direction (vertically up-ward) and pushes the first mold insert part (the sections of the first mold insert part) horizontally inward towards the molding position. If the first mold insert part consists of two or more sections (as described above) the biasing mechanism may comprise at least one spring in cooperation with each section. Instead of the at least one spring at least one other de-formable element can be employed that can be pre-biased by compression and that expands when the actuation element is moved along the second direction (downward direction) pushing therefore the first mold insert part (or its sections) horizontally outward.

In an alternative optional implementation, the actuation mechanism may further comprise repelling magnets positioned on the second mold insert part (e.g., on an outer side thereof facing the first mold insert part) and on each section of the first mold insert part (e.g., on an inner side thereof facing the second mold insert part) so that a repelling magnetic force is generated between the magnets of the second mold insert part and corresponding magnets on each section of the first mold insert part. The repelling magnetic force between the first mold insert part and the second mold insert part causes the first mold insert part to move (pivot) horizontally outward, when the at least one actuation element is moved along the second direction. By using long-lasting and compact repelling magnets, a robust and compact actuation mechanism can be obtained.

According to still another implementation, it is also conceivable that the actuation mechanism does not comprise any biasing mechanism to support the movement (pivoting) of the first mold insert part horizontally outward. In such an implementation the removal movement of the molded container, which is a movement in vertical upward direction, can be ex-ploited to push (each section of) the second mold insert part horizontally outward, when the at least one actuation element has been moved along the second direction (i.e., the first mold insert part is free to move horizontally outward). This implementation further simpli-fies the set-up of the forming tool.

The at least one actuation element may be designed to at least partially surround the mold insert in circumferential direction. The at least one actuation element may be designed to at least partially surround the first mold insert part and the second mold insert part in circumferential direction. Preferably, the at least one actuation element may be designed as a (sin-gle) frame element (referred to as actuation frame hereinafter) which surrounds the first mold insert part (and the second mold insert part) in circumferential direction. The actuation frame may be arranged to slide along the outer sides of the first mold insert part (and the second mold insert part) when the actuation frame is moved in the first vertical direction or second vertical direction. The described frame structure contributes to a compact mold design and further reduces the number of mold components and thus the complexity of the mold.

To facilitate the vertical movement of the at least one actuation element (actuation frame) along the outer side of the first mold insert part (and the second mold insert part), at least one roller may be mounted on the first mold insert part (or on each section thereof) such that the at least one roller gets in contact with an inner side of the at least one actuation element (actuation frame). The inner side of the at least one actuation element (actuation frame) is the side facing the outer side of the mold insert (first mold insert part).

Moreover, the inner side of the at least one actuation element (actuation frame) may have at least one corresponding recess (groove) located at a specific vertical position. The at least one recess is designed to partially receive the at least one roller, when the at least one actuation element (actuation frame) is vertically moved along the second direction. That is, when the at least one actuation element (actuation frame) is moved along the second direction, the at least one roller roll along the inner surface of the at least one actuation element (actuation frame) into the corresponding recess. The reception of the at least one roller in the corresponding recess enables the biasing mechanism to push (each section of) the first mold insert part horizontally outward, realizing thereby the demolding state.

The at least one actuation element (actuation frame) may be coupled with at least one actuator configured to move the at least one actuation element in the vertical direction. The at least one actuator may be a pneumatically, hydraulically and/or electrically driven actuator. The at least one actuator may be part of the forming tool or an external actuator provided by the forming machine in which the forming tool is mounted.

The forming tool may further comprise an upper tool part and a lower tool part cooperating with the upper tool part. The above-described mold insert and actuation mechanism may be part of the lower tool part or the upper tool part. According to one implementation the above-described mold insert and actuation mechanism may be arranged in the lower tool part. The lower tool part may comprise a lower clamping frame which surrounds the mold insert. The corresponding upper tool part may comprise an upper clamping frame and a pre-stretcher surrounded by the upper clamping frame. The upper clamping frame and the lower clamping frame are both arranged to get in contact with each other when the forming tool is closed (i.e., both tool parts are moved to one another) clamping thereby the web positioned between both tool parts. The pre-stretcher may be designed to push the web into the cavity to form a blank having a temporary shape that can be further brought into the final shape by applying compressed air or vacuum.

In accordance with one further aspect, a forming machine, in particular a thermoforming machine, is provided. The forming machine comprises the forming tool described herein.

In accordance with one further aspect, use of the forming tool described herein for producing a container from a two-dimensional web of material, in particular from a thermoplastic film, is provided.

In accordance with one further aspect, a method of producing a container from a two-dimensional web of material by using the forming tool described herein is provided. The method comprises the following steps: providing a two-dimensional web of material in the forming tool; moving the first mold insert part of the forming tool horizontally inward into a molding position to generate a cavity with an undercut region; molding the two-dimensional web of material in the cavity to form a three-dimensional container that assumes the shape of the cavity; moving the first mold insert part of the forming tool horizontally outward into a demolding position; and demolding the container in the cavity.

### BRIEF DESCRIPTION OF THE DRAWINGS

Further details and advantages of the invention are explained in greater detail using the following drawings.

FIG. 1 is a partial sectional view of an exemplary forming tool according to the present invention;

FIGS. 2a and 2b are sectional views of an exemplary actuation mechanism of the forming tool of FIG. 1;

FIGS. 3a to 3i are partial sectional views of the forming tool of FIG. 1 during different stages of a molding cycle; and

FIG. 4 is a flow chart describing a method of producing a container using the forming tool as described in connection with FIG. 1, FIGS. 2a and 2b and FIGS. 3a to 3i.

### DETAILED DESCRIPTION

In the following description, for purposes of explanation and not limitation, specific details are set forth in order to provide for a thorough understanding of the forming tool presented herein. It will be apparent to one skilled in the art that the disclosed forming tool, forming machine and method may comprise other embodiments that depart from these specific details.

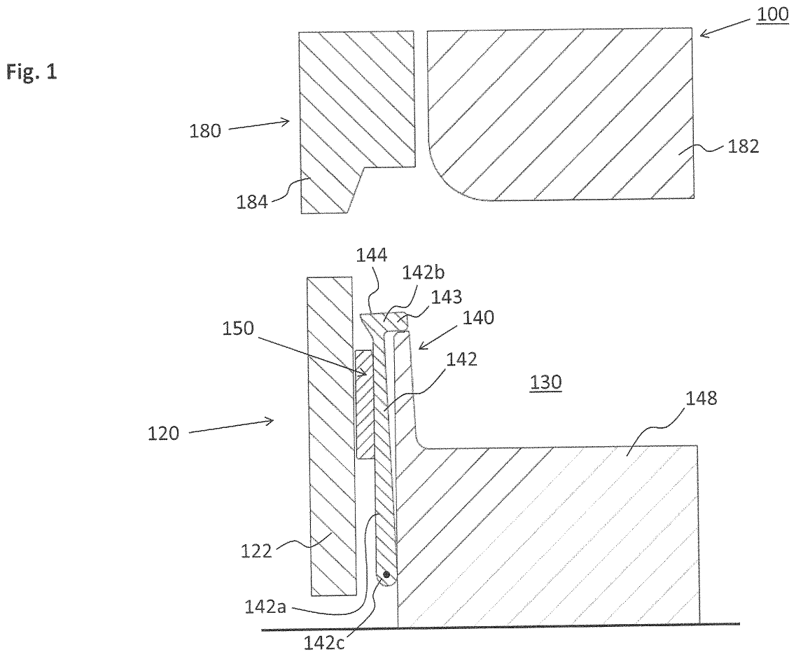

With reference to FIG. 1 one exemplary embodiment of a forming tool 100 according to the present invention is described. FIG. 1 shows a partial cross-sectional view of the forming tool 100.

The forming tool 100 of FIG. 1 is a thermoforming tool designed for reshaping two-dimensional (planar) sheets or webs of material into three-dimensional containers, such as, for example, cups, bowls or capsules. The containers may be produced from plastic material or a different material, such as, for example, cellulose.

The forming tool 100 comprises an upper tool part 180 and a lower tool part 120. The upper tool part 180 and the lower tool part 120 are mounted coaxially aligned with respect to each other in a forming machine (not shown in FIG. 1). More specifically the upper tool part 180 is mounted on an upper platen of the forming machine, while the lower tool part 120 is mounted on a lower platen of the forming machine.

In FIG. 1 the forming tool 100 is illustrated in its open position. In the open position the upper tool part 180 and the lower tool part 120 are spaced apart from each other so that a web of material can be placed in the space between them.

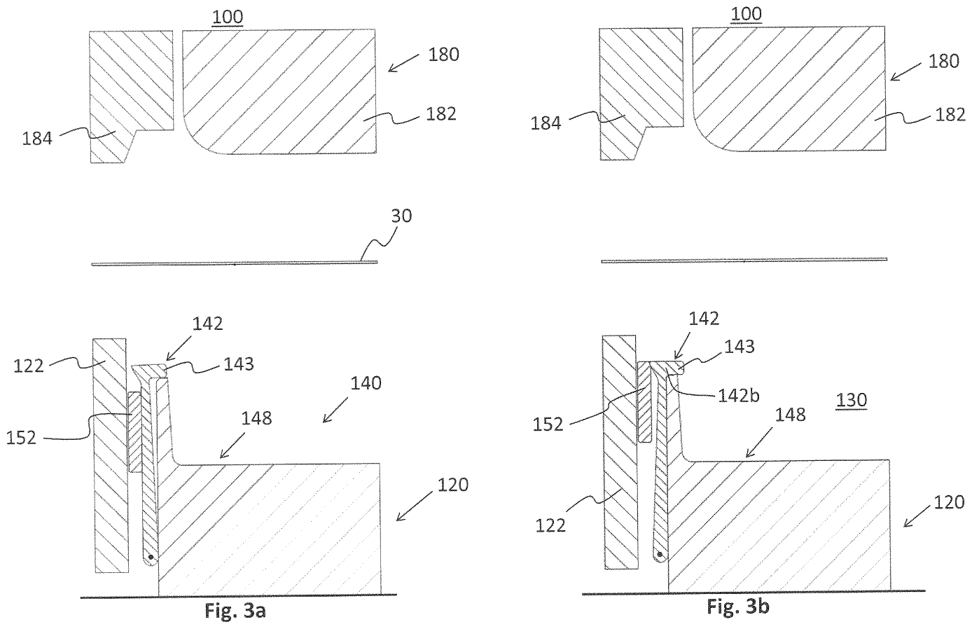

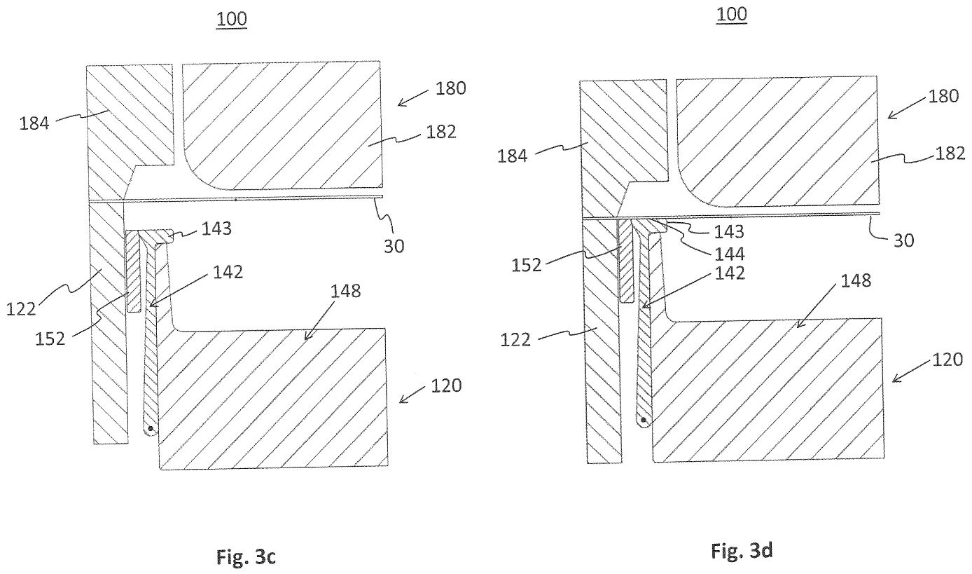

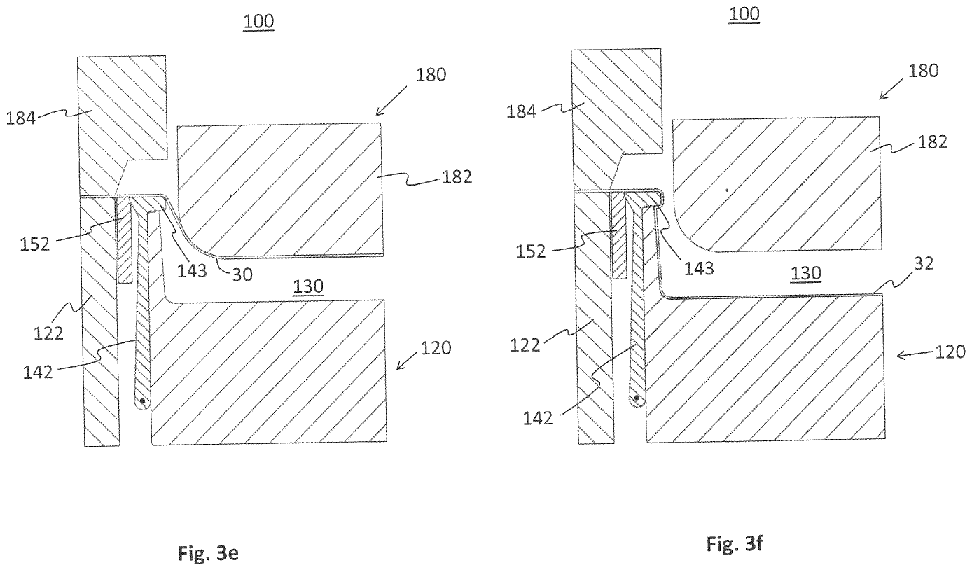

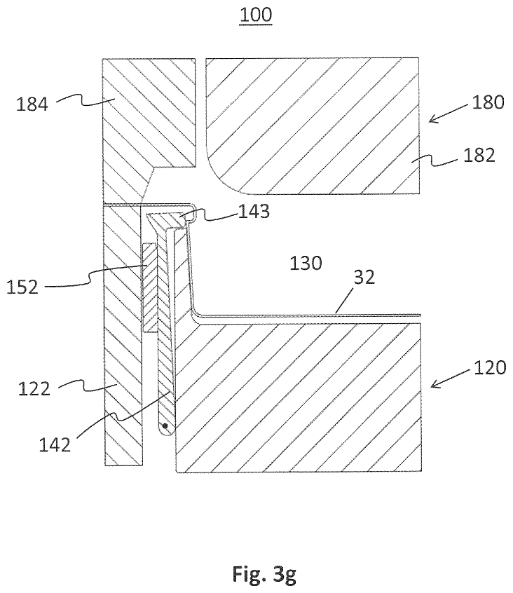

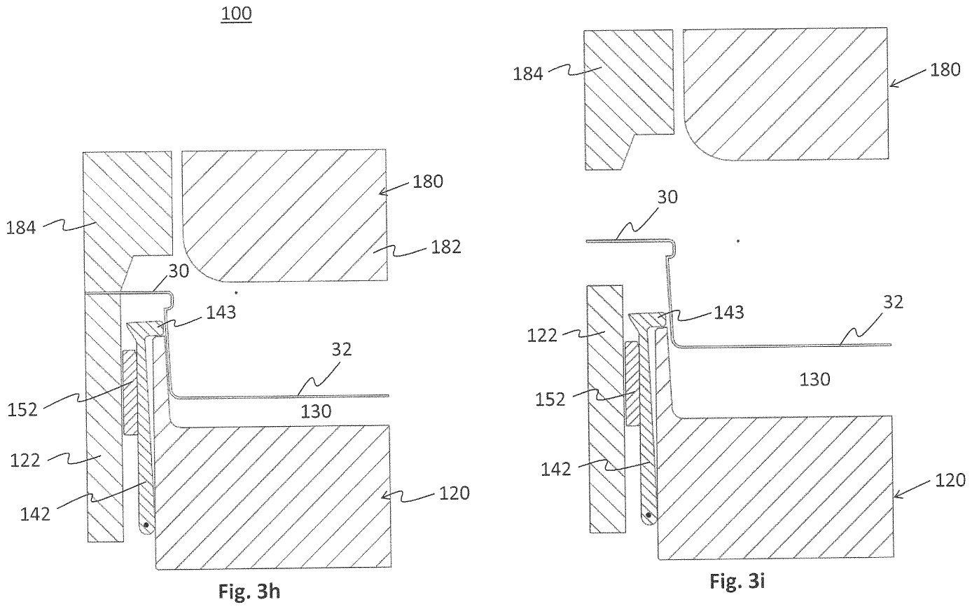

The upper tool part 180 comprises a pre-stretcher 182 and an upper clamping frame 184 (also referred to as downholder device 184 hereinafter). The pre-stretcher 182 is mounted displaceable within the upper clamping frame 184. The functionalities of the pre-stretcher 182 and the upper clamping frame 184 will be further described in connection with FIGS. 3a-3i showing various stages of a molding cycle. The pre-stretcher 182 is optional and can also be omitted in case the container to be formed has a low depth (or height).

The lower tool part 120 comprises a mold insert 140 and an actuation mechanism 150. The mold insert 140 and the actuation mechanism 150 are surrounded by a lower clamping frame 122 arranged to cooperate with the upper clamping frame 184 when the forming tool is brought into a closed position. The forming tool 100 is in its closed position when the upper tool part 180 and the lower tool part 120 are moved to each other such that the upper clamping frame 184 contacts the lower clamping frame 122 to clamp a web of material positioned between the lower tool part 120 and the upper tool part 180.

In the embodiment illustrated in FIG. 1 the mold insert 140 and the actuation mechanism 150 are part of the lower tool part 120. However, the present invention is not limited to this specific implementation. It is also conceivable that the mold insert 140 and the actuation mechanism 150 are part of the upper tool part 180, whereas the pre-stretcher 182 is omitted or arranged on the lower tool part 120.

In the following, the mold insert 140 will be described in more detail. The mold insert 140 consists of a first mold insert part 142 and a second mold insert part 148. Both mold insert parts 142, 148 define (build) together a cavity 130 provided for re-shaping a two-dimensional web of material into a corresponding three-dimensional container, such as a cup or bowl.

The second mold insert part 148 is designed as block element having a hollow space that defines a second (i.e., lower) portion of the cavity 130. More specifically, the second mold insert part 148 comprises at least one inner side wall that defines a lower portion of the side wall(s) of the cavity 130 and the bottom of the cavity 130. Alternatively, it is also conceivable that the bottom of the cavity 130 is defined by a separate bottom element arranged and vertically movable within the second mold insert part 148. Independent of the specific implementation of the bottom, i.e., whether the bottom is embodied as a separate movable element or not, the second mold insert part 148 is mounted stationary, i.e., it does not move within the forming tool 100.

The first mold insert part 142 consists of two or more sections arranged in circumferential direction. In the cross-sectional view of FIG. 1 only one section is illustrated. For each circumferential section the first mold insert part 142 comprises a lower portion 142a and an upper portion 142b. The number of sections depends on the shape of the container and/or on the shape of the undercut to be generated. For instance, it is conceivable that the first mold insert part 142 consists of two, three or four circumferential sections. However, it is also conceivable that the first mold insert part 142 consists of more than four sections.

The lower portion 142a of each circumferential section of the first mold insert part 142 is designed as pivoting element 142a. Each pivoting element 142a is arranged to partially surround the second mold insert part 148 in circumferential direction. Moreover, a pivoting shaft 142c (extending in horizontal direction) is provided for each pivoting element 142a so that the pivoting element 142a can be pivotally mounted at its lower end in the forming tool 100. According to one implementation the pivoting shaft 142c for each pivoting element 142a is arranged on the second mold insert part 148 at an outer side thereof. Thus, the pivoting element 142a is mounted in a pivoting manner at the second mold insert part 148. This configuration allows for a compact mold design.

The upper portion 142b of each circumferential section of the first mold insert part 142 is arranged on the upper end of the corresponding lower portion 142a and defines a first (i.e., upper) portion of the cavity 130. This upper portion of the cavity 130 comprises the opening of the cavity 130. The upper portion 142b of each circumferential section is designed to em-body at least one protrusion 143 and a top rim portion 144. The at least one protrusion 143 of each upper portion 142b extends in circumferential direction. More specifically, the at least one protrusion 143 is designed to be continuous in circumferential direction or inter-rupted by one or more recesses depending on the undercut design to be realized in the container.

In addition, the at least one protrusion 143 is designed to extend horizontally inward (i.e., it protrudes into the cavity 130) so that an undercut in the vicinity of the cavity opening can be generated. The at least one protrusion 143 is dimensioned in horizontal direction such that it protrudes into the cavity 130 when the upper portion 142b of each section of the first mold insert part 142 is moved (pivoted) horizontally inward into a molding position. On the other hand, the at least one protrusion 143 is dimensioned in horizontal direction such that it does not protrude into the cavity 130 when the upper portion 142b of each section of the first mold insert part 142 is moved (pivoted) horizontally outward into a demolding position. FIG. 1 shows the mold insert 140 in the demolding position.

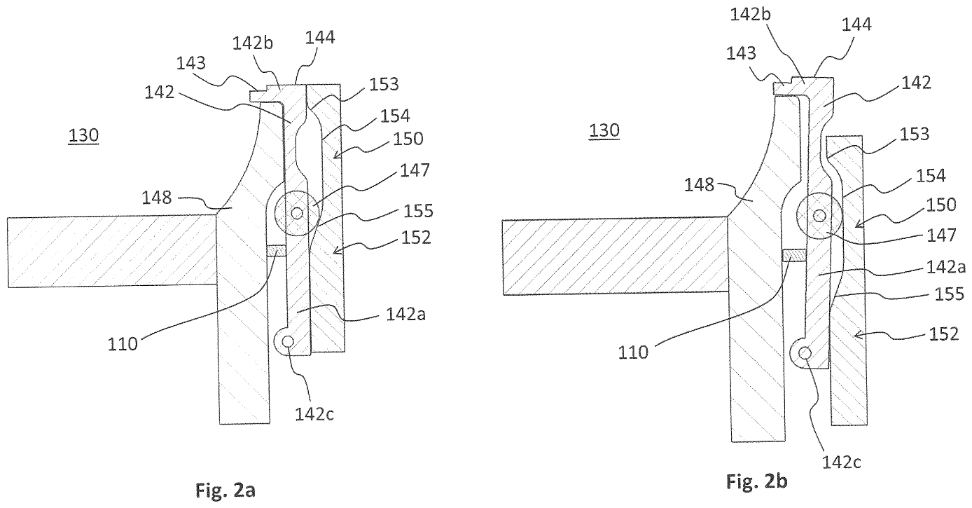

The actuation mechanism 150 is designed and arranged in the forming tool 100 to cooperate with (each section of) the first mold insert part 142 in such a way that (each section of) the first mold insert part 142 can be moved (pivoted) between the molding position and demolding position. One implementation of an actuation mechanism 150 according to the present invention will be described in more detail in connection with FIGS. 2a and 2b.

The lower clamping frame 122 is arranged in the forming tool 100 to surround the actuation mechanism 150 as well as the mold insert 140. The lower clamping frame 122 is movably mounted in the forming tool 100. More specifically, the lower clamping frame 122 is movable in vertical direction. The lower clamping frame 122 is moved in downward direction when the forming tool 100 is closed and the upper clamping frame 184 gets in contact with the lower clamping frame 122. Moreover, the lower clamping frame 122 is moved in upward direction when the forming tool 100 is opened. The functioning of the clamping frames 184 and 122 will be further described in connection with FIGS. 3a to 3i.

The lower clamping frame 122, the actuation mechanism 150 as well as the mold insert 140 are carried by a tool carrier (not shown in FIG. 1). The tool carrier, in turn, is mounted on a lower platen of a forming machine (not shown in FIG. 1).

With reference to FIGS. 2a and 2b, the actuation mechanism 150 is further described. The actuation mechanism 150 comprises at least one actuation element 152 mounted vertically movable in the forming tool 100. The actuation element 152 has a frame-like structure (also referred to as actuation frame 152 hereinafter) that is arranged to at least partially surround the first mold insert part 142 (and the second mold insert part 148) in circumferential direction. According to one variant the actuation frame 152 fully surrounds the mold insert 140 (i.e., the first mold insert part 142 and the second mold insert part 148) in circumferential direction. Moreover, the actuation frame 152 is coupled with at least one pneumatically, hydraulically and/or electromechanically operated actuator configured to selectively move up and down the actuation frame 152. The at least one actuator is not illustrated in the FIGS. 2a and 2b and may be part of the forming tool 100 or a forming machine in which the forming tool 100 is mounted.

The inner side 153 of the actuation frame 152 is in contact with at least one roller 147 mounted at the lower portion 142a of each section of the first mold insert part 142. At least one roller 147 is rotatably mounted in a corresponding recess or opening of each lower portion 142a of the first mold insert part 142. The at least one roller 147 may be a cylindrical roller.

Moreover, the inner side 153 of the actuation frame 152 comprises at least one recess 154 positioned at a predetermined vertical position to partially receive the at least one roller 147. More specifically, the actuation frame 152 may comprise a corresponding recess 154 for each roller 147 of each section of the first mold insert part 142. An inclined surface 155 is further provided at the lower transition between each recess 154 and the inner surface 153. Hence by moving the actuation frame 152 vertically upward, the at least one roller 147 can roll along the inclined surface 155 pushing thereby each section of the first mold insert part 142 horizontally inward. At the end of this movement in upward direction each section of the first mold insert part 142 is pivoted horizontally inward so that the at least one protrusion 143 protrudes into the cavity 130. This configuration is illustrated in FIG. 2a and shows the molding position.

By moving the actuation frame 152 in downward direction, the at least one roller 147 moves along the inclined surface 155 into the recess 154 so that each section of the first mold insert part 142 can move horizontally outward. In order to support this movement at least one biasing element 110, such as, for example, a spring or repelling magnets, is/are provided that push(es) each section of the first mold insert part 142 horizontally outward as soon as the actuation frame 152 moves downward and the at least one roller 147 is received in the corresponding at least one recess 154. This configuration in which the actuation frame 152 is moved downward and the first mold insert part 142 is pivoted horizontally outward is illustrated in FIG. 2b and shows the demolding position. In this configuration the at least one protrusion 143 is retracted from the cavity 130 so that a molded container can be demolded from the mold insert 140.

In the embodiment illustrated in FIGS. 2a and 2b at least one spring 110 is positioned between an outer surface of the second mold insert part 148 and an inner surface of the first mold insert part 142 to push the first mold insert part 152 horizontally outward. More specifically, a spring is positioned between each section of the first mold insert part 142 and the second mold insert part 148 to push each section horizontally outward when the actuation frame 152 is moved downward. Instead of the at least one spring 110 other biasing elements are conceivable to generate a pushing force onto each section of the first mold insert part 142 in horizontal outward direction. For instance, repelling magnets may be positioned on (the outer side of) the second mold insert part 148 and on (the inner side of) each section of the first mold insert part 142 so that a repelling magnetic force is generated between the magnets of the second mold insert part 148 and corresponding magnets on each section of the first mold insert part 142.

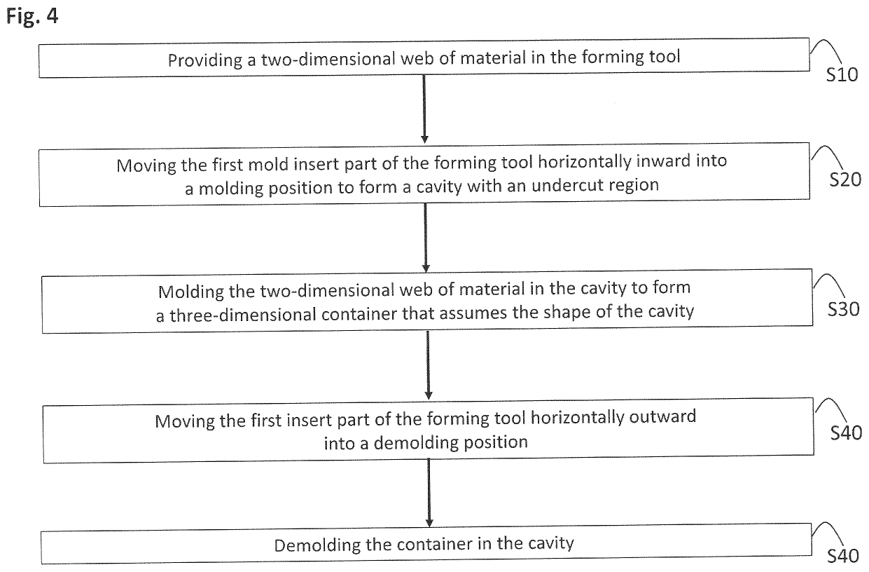

With reference to FIGS. 3a to 3i and FIG. 4 a method of producing a container from a two-dimensional web of material using the forming tool 100 is further described. While FIG. 4 shows a sequence diagram describing the method steps in more general terms, FIGS. 3a to 3i show the forming tool 100 at different stages during the production process.

In a first step S10 (see FIG. 4) a two-dimensional web of material is provided in the forming tool 100. Since the forming tool 100 is a thermoforming tool 100 a thermoplastic film 30 is provided. This step is performed when the forming tool 100 is opened. This is illustrated in FIG. 3a where the two forming tool parts 120, 180 are spaced apart and the film 30 is positioned between them. Moreover, the actuation frame 152 is in a vertical downward position so that (each section of) the first mold insert part 142 is pivoted horizontally outward and is therefore in a demolding position, in which the at least one protrusion 143 generating the undercut is retracted from the cavity 130. The lower clamping frame 122 is in a vertical upward position.

In a subsequent step S20 (each section of) the first mold insert part 142 of the forming tool 100 is moved horizontally inward into a molding position to generate a cavity 130 with an undercut region (see FIG. 4 and FIG. 3b). The forming tool 100 is still opened with spaced apart lower and upper tool parts 120, 180. The actuation frame 152 is moved vertically upward. This vertical movement of the actuation frame 152 pushes (each section of) the first mold insert part 142 horizontally inward. Since the first mold insert part 142 is pivotally mounted in the forming tool 100, the movement in upward direction of the actuation frame 152 causes (each section of) the first mold insert part 142 to pivot horizontaly inward. The at least one protrusion 143 on the upper portion 142b of (each section of) the first mold insert part 142 protrudes in the cavity 130 so that an undercut is realized in the vicinity of the opening of the cavity 130 at the transition between the first mold insert part 142 and the second mold insert part 148.

In a subsequent step S30 (see FIG. 4) the thermoplastic film 30 positioned between the two tool parts 120, 180 is molded into the cavity 130 to form a three-dimensional container 32. The molding step S30 is illustrated in FIGS. 3c to 3f and comprises the following sub-steps. In a first sub-step the two tool parts 120, 180 are moved to one another to close the forming tool 100. In FIG. 3c the upper tool 180 is moved downward so that the upper clamping frame 184 gets in contact with the lower clamping frame 122 and clamps the film 30 in between. Thereafter, the upper tool 180 is further moved downward, pushing thereby the vertically movable lower clamping frame 122 downwards until the clamped film 30 gets in horizontal alignment with the top rim 143 of the first mold insert part 142 (see FIG. 3d). Thereafter and in a further sub-step, the pre-stretcher 182 is moved down into the cavity 130 to form a pre-stretched blank (see FIG. 3e). In a further sub-step compressed air is in-troduced to fully draw the film towards the inner side walls of the cavity 130 and the bottom to form the container 32 (see FIG. 3f).

After the container 32 has been molded (and partially cooled down), (each section of) the first mold insert part 142 is moved horizontally outward into a demolding position in a subsequent step S40 (see FIG. 4). This demolding position is achieved by moving the actuation frame 152 vertically downward so that (each section of) the first mold insert part 142 is released (see FIG. 3g) and can be pushed by the at least one biasing spring horizontally outward (see FIG. 3h). As further shown in FIG. 3g the pre-stretcher 182 is meanwhile removed from the cavity 130 and also the upper tool part 180 has been started to move in upward direction so that the film 30 clamped between both clamping frames 122, 184 and the container 32 are slightly lifted (see also FIG. 3g). Since the at least one protrusion 143 of the first mold insert part 142 does no longer protrude into the cavity 130, the demolding of the container 32 can be easily and safely performed (see also FIG. 4, step S40).

After demolding the container 32, the forming tool 100 is opened by further moving the upper tool 180 in upward direction (see FIGS. 3h and 3i). In the open position, the container 32 can be removed from the forming tool 100 and a new thermoplastic film section can be positioned in the opened forming tool 100 for a subsequent molding cycle.

The above-described forming tool enables the molding of containers with pronounced undercut regions. Moreover, the actuation mechanism according to the present invention has a robust and compact design.

1. A forming tool, for producing a container the forming tool comprising:
a mold insert comprising a first mold insert part and a second mold insert part that together define a cavity provided for reshaping a two-dimensional web of material into a container, wherein the first mold insert part comprises at least one protrusion and is mounted horizontally movable in the forming tool; and
an actuation mechanism designed to move the first mold insert part horizontally inward into a molding position, in which the at least one protrusion extends into the cavity to generate an undercut region in the cavity

2. The forming tool of claim 1, wherein the actuation mechanism is further designed to move the first mold insert part horizontally outward from the molding position into a demolding position, in which the at least one protrusion is retracted from the cavity

3. The forming tool according to claim 1, wherein the first mold insert part comprises at least two sections arranged in circumferential direction, wherein the actuation mechanism is designed to move each section of the first mold insert part horizontally inward into the molding position.

4. The forming tool according to claim 1, wherein the first mold insert part comprises at least two sections arranged in circumferential direction, wherein the actuation mechanism is designed to move each section of the first mold insert part horizontally outward into a demolding position.

5. The forming tool according to claim 1, wherein the first mold insert part is pivotally mounted in the forming tool.

6. The forming tool according to claim 1, wherein the first mold insert part is arranged in the forming tool to at least partially surround the second mold insert part.

7. The forming tool according to claim 1, wherein the second mold insert part is designed to define a lower portion of the cavity.

8. The forming tool according to claim 1, wherein the first mold insert part is designed to define an upper portion of the cavity.

9. The forming tool according to claim 1, wherein the actuation mechanism comprises at least one actuation element mounted vertically movable in the forming tool, and operatively connected with the first mold insert part to move the first mold insert part horizontally inward into the molding position when the actuation element is moved along a first vertical direction.

10. The forming tool according to claim 1, wherein the actuation mechanism comprises at least one actuation element mounted vertically movable in the forming tool, and operatively connected with the first mold insert part to move the first mold insert part horizontally outward into a demolding position when the at least one actuation element is moved along a second vertical direction.

11. The forming tool according to claim 10, wherein the actuation mechanism further comprises a biasing mechanism designed to push the first mold insert part horizontally outward into the demolding position when the at least one actuation element is moved along the second direction.

12. The forming tool according to claim 2, wherein the at least one actuation element has a frame structure designed to at least partially surround the mold insert parts

13. The forming tool according to claim 9, wherein the at least one actuation element has at least one recess at its inner side facing the first mold insert part the at least one recess being arranged to partially receive at least one roller that is rotatably mounted on the first mold insert part when the at least one actuation element is moved along the second direction.

14. The forming tool according to claim 9, wherein the at least one actuation element is coupled with at least one pneumatically, hydraulically and/or electrically driven actuator configured to move the at least one actuation element in vertical direction.

15. The forming tool according to claim 1, wherein the forming tool comprises an upper tool part and a lower tool part cooperating with the upper tool part wherein the mold insert is part of the lower tool part or the upper tool part

16. A a thermoforming machine, comprising the forming tool according to claim 1.

17. A method of using the forming tool according to any claim 1 for producing a container from a two-dimensional web of material.

18. A method of producing a container from a two-dimensional web of material by using the forming tool of any claim 1, wherein the method comprises steps:
providing a two-dimensional web of material in the forming tool;
moving the first mold insert part of the forming tool horizontally inward into a molding position to generate a cavity with an undercut region;
molding the two-dimensional web of material in the cavity to form a three-dimensional container that assumes the shape of the cavity;
moving the first mold insert part of the forming tool horizontally outward into a demolding position; and
demolding the container in the cavity.
